(19) United States
(12) Patent Application Publication
(10) Pub. No.: US 2016/0178535 A1
(43) Pub. Date: Jun. 23, 2016

(54) Inspection Device And Method

(71) Applicant: Xerox Corporation, Norwalk, CT (US)

(72) Inventor: David J. Houston, West Linn, OR (US)

(73) Assignee: Xerox Corporation

(21) Appl. No.: 14/573,839

(22) Filed: Dec. 17, 2014

(51) Int. Cl. G01N 21/958; G01N 21/88

(52) U.S. Cl. CPC G01N 21/958; G01N 21/8803; G01N 21/8806

(57) ABSTRACT

An inspection device including an illumination source emitting illumination that is divided into lighter and darker bands; a viewing system placed a first distance from the illumination source; a material to be evaluated placed a second intermediate distance between the illumination source and the viewing system on an imaginary line connecting the viewing system and at least some portion of the source of illumination. An inspection process including placing a material to be evaluated between an illumination source emitting illumination that is divided into lighter and darker bands and a viewing system placed a first distance from the illumination source; wherein the material to be evaluated is placed at a second intermediate distance between the illumination source and the viewing system, and on an imaginary line connecting the viewing system and illumination source; illuminating the material; and evaluating the material with the viewing system.

### BACKGROUND

Disclosed herein is an inspection device and method. More particularly disclosed herein is an inspection device comprising an illumination source emitting illumination that is divided into lighter and darker bands; a viewing system placed a first distance from the illumination source; a material to be evaluated placed at a second intermediate distance between the illumination source and the viewing system, the material to be evaluated also placed on an imaginary line connecting the viewing system and at least some portion of the source of illumination.

There are a large number of uses for transparent films and tapes. For example, transparent films and tapes are used to manufacture solid ink jet print heads. Thickness variations in the transparent films and tapes can result in yield loss in production processes. Such defects often result in the necessity to reject sections of tape. Rejects that are missed can cause scrap further down the process. This can result in loss that can be 100 times the cost of the tape itself. Thickness variations can result from streaks down the length of the tape or from point defects. Because the tape is transparent, and particularly if the tape has liners on it, it can be difficult to inspect for defects. Neither back lighting nor overhead lighting is effective for visually inspecting these tapes. Many defects elude detection, and inspection can be tedious and slow. Proposed solutions to the problem have thus far been expensive and required considerable complex setup for a particular tape.

While currently available inspection methods are suitable for their intended purposes, a need remains for improved inspection devices and methods. Further, a need remains for an improved device and process for evaluating transparent films and tapes. Further, a need remains for a device and process for evaluating transparent films and tapes that is effective, inexpensive, and easy to carry out. Further, a need remains for a device and process for evaluating transparent films and tapes that can be readily tailored to various materials of differing thicknesses.

The appropriate components and process aspects of the each of the U. S. Patents and Patent Publications herein may be selected for the present disclosure in embodiments thereof. Further, throughout this application, various publications, patents, and published patent applications are referred to by an identifying citation. The disclosures of the publications, patents, and published patent applications referenced in this application are hereby incorporated by reference into the present disclosure to more fully describe the state of the art to which this invention pertains.

### SUMMARY

Described is an inspection device comprising an illumination source emitting illumination that is divided into lighter and darker bands; a viewing system placed a first distance from the illumination source; a material to be evaluated placed at a second intermediate distance between the illumination source and the viewing system, the material to be evaluated also placed on an imaginary line connecting the viewing system and at least some portion of the source of illumination.

Also described is an inspection process comprising placing a material to be evaluated between an illumination source emitting illumination that is divided into lighter and darker bands and a viewing system placed a first distance from the illumination source; wherein the material to be evaluated is placed at a second intermediate distance between the illumination source and the viewing system, the material to be evaluated also placed on an imaginary line connecting the viewing system and at least some portion of the source of illumination; illuminating the material to be evaluated with the illumination source; and evaluating the material to be evaluated with the viewing system.

### BRIEF DESCRIPTION OF THE DRAWINGS

FIG. 1 is an illustration of an inspection device in accordance with the present disclosure.

FIG. 2 is an illustration of a portion of the inspection device of FIG. 1, showing a non-uniformity or defect in the thickness of a film to be inspected.

FIG. 3 is an illustration of a portion of the inspection device of FIG. 1, showing a streak in a film to be inspected and the angle of the streak to the long axis of the bars.

FIG. 4 is an illustration showing a material to be inspected in front of a transparency in accordance with the present embodiments and how previously invisible variation in adhesive thickness, not visible with the naked eye or with use of an ordinary light box, is now obvious with use of the present device and method.

### DETAILED DESCRIPTION

A device and process for detecting variations in transparent films and tapes is described. The device is particularly useful for detecting minor thickness variations in transparent coatings. Thickness variations in an adhesive tape or transparent film create a lens effect. A light box with uniform illumination behind the tape is ineffective because the lens effect moves light from one area of uniform illumination to another. A single slit or other single light-to-dark transition will create a lens effect, but it does not allow large areas to be inspected at once.

The present device and process can be used for detecting variations in any suitable or desired material. In embodiments, two different transparent adhesive materials are inspected with this invention. One embodiment is a silicone PSA (pressure sensitive adhesive) comprising an amber polyimide sheet with a nominal 0.0004 inch layer of clear silicone adhesive on either side, with clear polyester liners on both sides to protect the adhesive. Subtle non-uniformities in the thickness of the PSA tape can cause manufacturing defects in the end use application of the PSA. The PSA is inspected for non-uniformities three times: by the tape manufacturer, by the convertor, and in the Xerox® process. However, it is difficult to see some types of defects and a number of defects can pass through all inspections undetected. Sometimes these defects can be seen with more or less difficulty by an operator holding the PSA at a particular orientation to the available illumination. This does not provide a reproducible or reliable method for manufacturing.

In another embodiment, a second transparent adhesive material inspected with the present invention is an acrylic transfer adhesive; in embodiments, a clear, thermoset adhesive coated 0.0005 to 0.004 inch thick on either polyester or polyimide substrates and protected with a polyester laminate. The coating can have streaks in the machine direction from problems with the coating die. It can also have point defects from particulate contamination, fish eyes, or bubbles. These defects all can cause problems in the end use application of the adhesive. Without an effective inspection method, scrap material can be generated in downstream processes with a value many times that of the adhesive, necessitating thorough detection of defects in the tape before further processing.

Systems with lasers or LED (light emitting diode) arrays are available in the industry and are used to inspect for defects. They are used in high volume, critical applications. Production of photographic film is an example. There are significant drawbacks to laser systems: high cost, fixed installation, extensive setup, and unsuitability for engineering samples or piecework. The present disclosure provides a lost cost, quickly deployed, and suitable device and process for small or large scale operations.

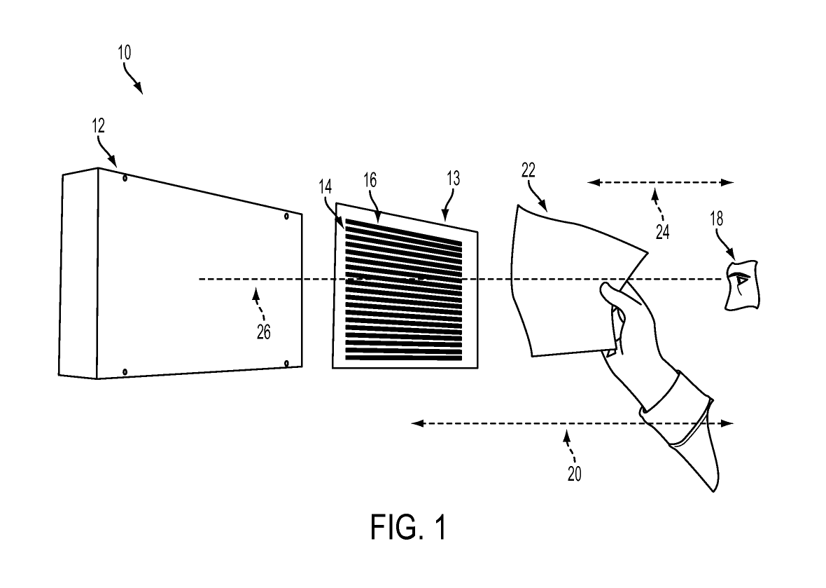

With reference to FIG. 1, an inspection device 10 in accordance with the present disclosure comprises an illumination source 12, for example, a non-point illumination source 12, emitting illumination through a transparency 13 having light and dark bars. In embodiments, transparency 13 has bars that are divided into lighter bands 14 and darker bands 16. The inspection device includes a viewing system 18. The transparency 13 is placed a first distance 20 from the viewing system 18. A material to be evaluated 22, in embodiments, a transparent sample to be inspected 22, is placed at a second intermediate distance 24 from the viewing system 18 on an imaginary line 26 from the viewing system 18 through the sample to be inspected 22, through the transparency 13 having the array of bars 14, 16, to at least some portion of the source of the illumination 12.

An inspection process in accordance with the present disclosure comprises, in embodiments, placing a material to be evaluated between a non-point illumination source emitting illumination that is divided into lighter and darker bands and a viewing system placed a first distance from the illumination source; wherein the material to be evaluated is placed at a second intermediate distance between the illumination source and the viewing system, the material to be evaluated also placed on an imaginary line connecting the viewing system and at least some portion of the source of illumination; illuminating the material to be evaluated with the illumination source; and evaluating the material to be evaluated with the viewing system.

Material to be Evaluated. The device and process can be used to evaluate any suitable or desired material. In embodiments, the material to be evaluated is a transparent or semi-transparent material. In embodiments, the material to be evaluated comprises a layered material. In some embodiments, the material to be evaluated comprises a layered material having at least two layers. In other embodiments, the material to be evaluated comprises a layered material having at least three layers, wherein at least one layer to be inspected is sandwiched between one or more other layers.

The material to be evaluated comprises at least one feature to be evaluated. In embodiments, lighter and darker bands illuminating from the light source subtend a visual angle that is between from about 0.5 to about 8 times a subtended visual angle of a smallest dimension of the feature to be evaluated.

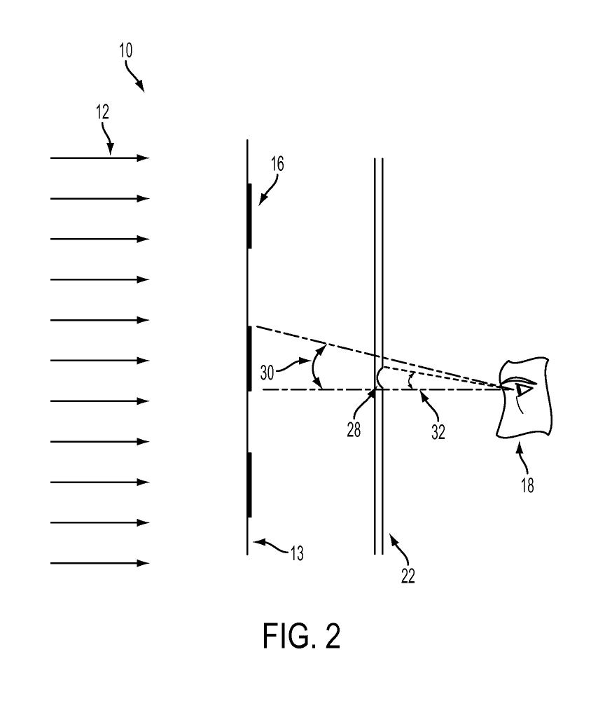

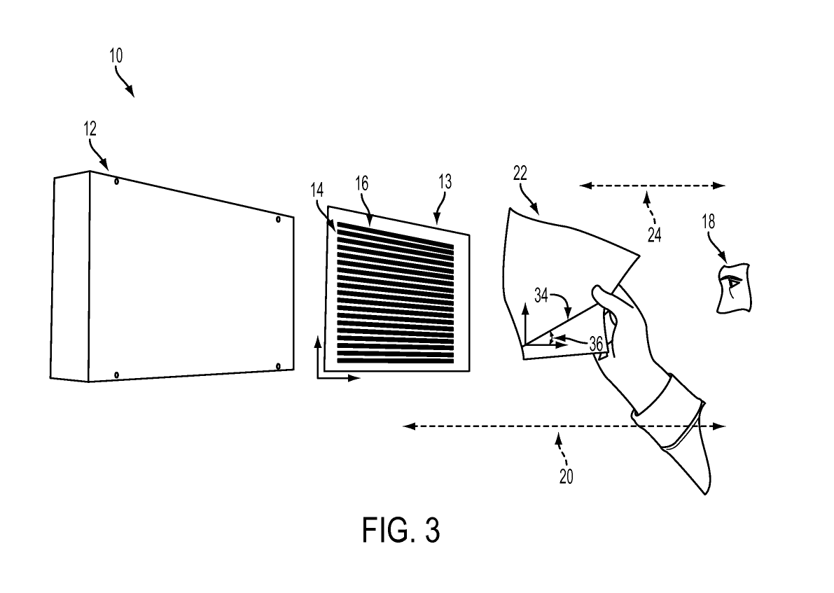

With reference to FIG. 2, wherein like elements are numbered as in FIG. 1, a non-uniformity 28 in the thickness of a film to be inspected 22 is shown. Visual subtended angle of the dark bars 30 and visual subtended angle 32 of the defect 28 are shown in FIG. 2. FIG. 3 shows a streak 34 in the film to be inspected 22 and the angle 36 of the streak 34 to the long axis of the bars 14, 16.

In embodiments, the lighter bands are provided in a width that is between from about 0.2 to about 1.5 times the width of the darker bands.

In embodiments, the material to be evaluated can be kept in motion until at least one feature to be evaluated is detected by the viewing system. The material can be kept in motion by any suitable or desired method, including use of a conveyer belt, a rotating drum, a roller, and combinations thereof, although not limited.

The material to be evaluated is placed between the illumination source and the viewing system. The viewing system is placed a first distance from the illumination source and the material to be evaluated is placed a second intermediate distance from the illumination source. In embodiments, the distance of the material to be evaluated from the viewing system is from about 20 percent to about 90 percent of the distance from the viewing system to the illumination source.

In embodiments, an angle between a long axis of the bands of illumination and a long axis of a feature to be evaluated is from about 15 degrees to about 70 degrees.

Illumination Source. Any suitable or desired illumination source can be selected for embodiments herein. The illumination source can comprise a dynamic light source. In some embodiments, the illumination source is selected from the group consisting of a flat panel display, a light emitting diode array, a cathode ray tube, a liquid crystal shutter, a video projector, a collimated light source emitting a deflected beam of variable intensity, and combinations thereof. In embodiments, the illumination source emits a white light. In other embodiments, the illumination source emits a colored light. In yet other embodiments, the illumination source emits a substantially monochromatic illumination.

In certain embodiments, the illumination source comprises a light box, and a transparency is placed over the light box. The transparency can have disposed thereon an alternating pattern of uniform light and dark bars that are angled to the direction of streaks on a tape, for example, at an angle of 45 degrees. The sample to be inspected can be held between the viewing system and the illumination source, at some distance from both. Streaks in the tape generate a vivid displacement of the bar pattern. Point defects are also accentuated as they displace illumination between light and dark bars.

In certain embodiments, the light source comprises a system wherein a field of illumination is created by placing a transparency on a light box, wherein the transparency contains a regular pattern of lighter and darker bars. In these embodiments, the process comprises creating a bar pattern comprising a regular pattern of clear and black bars, placing a sample to be evaluated a distance from the bar pattern; disposing a viewer a distance from the sample; and evaluating the sample using the viewer. The process can include orienting the black bars of the pattern at an angle to an expected streak direction on the sample. Thus, in certain embodiments, the device and process comprise evaluating transparent films using a pattern of light and dark bars.

The bar pattern can be provided in any suitable or desired configuration. In embodiments, the pattern of clear and black bars have the black bars provided in a pattern having a width that is wider when the process is performed when the sample is placed at a greater distance from the bar pattern and the viewer and wherein the black bars are provided in a pattern having a width that is narrower when the sample is placed at a lesser distance from the bar pattern and the viewer.

In certain embodiments, the pattern contains an alternating series of thin black bars and thin clear bars. In other embodiments, the pattern contains an alternating series of wide black bars and wide clear bars. In other embodiments, the pattern contains an alternating series of wide black bars and thin clear bars.

In other embodiments, the pattern contains an alternating series of thin black bars and wide clear bars.

The effect is dependent on the apparent visual angle of the bars, thus larger bars can be selected when the tape is a larger distance from the light box. A manual bench top inspection station with close working distances would favor selecting narrower bars, while an in-line inspection station on a coater with longer working distances would favor using larger bars.

The black bars can be placed at an angle to the expected streak direction of a defect. The black bars can be oriented at any suitable or desired angle. However, as the angle approaches zero, the effect of the bars goes away and the streaks are no longer accentuated. In certain embodiments, the process comprises orienting the black bars of the pattern at an angle of at least about 15 degrees.

Thus, in certain embodiments, the illumination source herein comprises a transparency disposed on a light box. The transparency comprises a regular pattern of clear and black bars. The tape sample or other material to be evaluated is held away from the light box by some distance that isn't critical. The viewing system, such as a viewer's eye or camera, is disposed another distance away from the tape, also not critical. In embodiments, the distance from the illumination source to the material to be evaluated is about 12 inches and the distance from the material to be evaluated to the viewing system is about 18 to about 24 inches. For streaks, the bars can be oriented at an angle to the expected streak direction. The exact angle can be selected as desired, but as the angle approaches zero (less than about 15 degrees), the effect of the bars goes away and the streaks are no longer accentuated. The width of the bars can also be selected as desired. The effect is dependent on the apparent visual angle of the bars, so larger bars can be selected for larger separations of the material to be evaluated from the illumination source and the viewing system. A manual bench-top inspection station with close working distances would use narrower bars, while an in-line inspection station on a coater with longer working distances would use larger bars.

Viewing System. Any suitable or desired viewing system can be selected for embodiments herein. The viewing system can be one that is capable of detecting and recording aspects of features of the material to be evaluated. In embodiments, the viewing system is selected from the group consisting of a human being, a stills camera system, a video camera system, a charge-coupled device array, and combinations thereof. In a specific embodiment, the viewing system is a human being who visually evaluates the material to be evaluated. In certain embodiments, the viewing system is one that is capable of more than monocular sensing. Examples of viewing systems that are capable of more than monocular sensing include human beings, dual still cameras, dual video cameras, and combinations thereof, although the present disclosure is not limited to these examples.

In embodiments, the device and process herein can employ a dynamic light source for creating a bar pattern. In certain embodiments, the illumination source is an illumination source that is capable of dynamically changing the band pattern. For example, a flat panel display, CRT (cathode ray tube) or video projector can be selected in place of a light box with a transparency. For manual inspection, such embodiments enable rapid optimization of the bar pattern for a particular inspection configuration by cycling through a number of bar widths and orientations. For automated inspection, these embodiments enable detecting of defects in different orientations or on different size scales. For example, consider a coater running at 100 feet per minute and a video camera with a frame rate of 30 frames per second. In 1/30 of a second, the web will move 0.66 inches. The first frame is captured with the bar pattern at 45 degrees to the direction of motion. This would detect any defect except streaks running close to 45 degrees across the web. The second frame is captured with the bar pattern at 90 degrees to the direction of motion. This would capture any streaks not detected in the first frame. Thus, these embodiments provide a simple machine vision task to superimpose the two images by accounting for the known motion of the web. This A-B acquisition pattern could be repeated continuously every 1/15 of a second (2 frames). If latency of the light source is problematic, the pattern could be repeated every 4 frames, which would still have a small enough motion of the web to allow superimposing of the two images.

Thus, the instant embodiments provide a low cost and easily implemented inspection device and method. In embodiments, the inspection device and method can be implemented using a light box, word processing software, and a digitally printed transparency. The present embodiments can also be used for both stationary and moving film. The device and method can visualize defects for the unaided eye, unlike many present systems which required sophisticated software setup and analysis.

### EXAMPLES

The following Examples are being submitted to further define various species of the present disclosure. These Examples are intended to be illustrative only and are not intended to limit the scope of the present disclosure. Also, parts and percentages are by weight unless otherwise indicated.

Example 1

A production silicone PSA comprising an amber polyimide sheet with a nominal 0.0004 inch layer of clear silicone adhesive on either side, with clear polyester liners on both sides of the adhesive was used to demonstrate the instant embodiments. A bar pattern was generated using Microsoft® Word word processing software and printed on a transparency. The transparency was placed on an ordinary light box. Defects that were invisible on the light box and very difficult to see or undetectable in other lighting conditions became obvious.

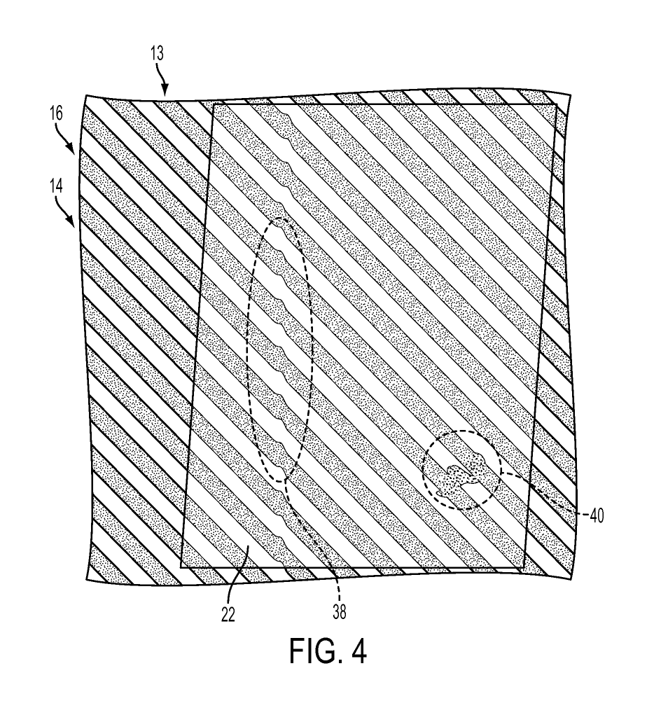

FIG. 4 is an illustration showing previously invisible variation in adhesive thickness of a film, not visible with the naked eye or with use of an ordinary light box, which is now obvious with use of the present device and method. FIG. 4 shows how a vertical, invisible to the naked eye streak in the top, brown film disrupts the appearance of the angled bar pattern on the transparency. As shown in FIG. 4, transparent sample to be inspected 22 is placed in front of transparency 13 having lighter bands 14 and darker bands 16. Distortion pattern 38 caused by a streak in the film being inspected can now be seen with use of the present embodiments. Distortion 40 from a piece of foreign material trapped in the film 22 can also be seen with use of the present embodiments.

In embodiments, there is a greater distortion of the bar pattern caused by the deeper, intentional horizontal cuts than is caused by the streak. By measuring the amount of distortion, for example with machine vision, the magnitude of the defect can be determined and quality control limits can be set. In embodiments, these bars have a 0.23 inch pitch, photographed with an 85 millimeter lens on a Nikon® D-100 camera, f/25, from a distance of about 1.5 feet.

In embodiments, the bars of the transparency can be placed at a smaller angle to the streak on the material to be inspected. Notice that the visibility of the streak is not much changed with a substantial change in bar orientation. In embodiments, for example, the transparency bars have a 0.155 inch pitch. In some embodiments, a much wider bar pattern with a 0.425 inch pitch is provided. The visibility of the streaks may be reduced somewhat but are still obvious. The width of the bars is not critical. Thus, with the present device and method, when inspecting by eye, the effect is more vivid than the appearance in an illustration or on a printed photograph. With a camera, the tape and the bars need to be in focus together, requiring a high f number. The drawings herein were based on photographs taken with an f-stop of about f/25.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims. Unless specifically recited in a claim, steps or components of claims should not be implied or imported from the specification or any other claims as to any particular order, number, position, size, shape, angle, color, or material.

1. An inspection device comprising:
an illumination source emitting illumination that is divided into lighter and darker bands;
a viewing system placed a first distance from the illumination source;
a material to be evaluated placed at a second intermediate distance between the illumination source and the viewing system, the material to be evaluated also placed on an imaginary line connecting the viewing system and at least some portion of the source of illumination.

2. The inspection device of claim 1, wherein the material to be evaluated is a transparent or semi-transparent material.

3. The inspection device of claim 1, wherein a field of illumination is created by placing a transparency on a light box, wherein the transparency contains a regular pattern of lighter and darker bars.

4. The inspection device of claim 1, wherein the illumination source is capable of dynamically changing the band pattern.

5. The inspection device of claim 1, wherein the illumination source is selected from the group consisting of a flat panel display, a light emitting diode array, a cathode ray tube, a liquid crystal shutter, a video projector, a collimated light source emitting a deflected beam of variable intensity, and combinations thereof.

6. The inspection device of claim 1, wherein the viewing system is selected from the group consisting of a human being, a stills camera system, a video camera system, a charge-coupled device array, and combinations thereof.

7. The inspection device of claim 1, wherein the viewing system is one that is capable of more than monocular sensing.

8. The inspection device of claim 1, wherein the material to be evaluated comprises at least one feature to be evaluated, and wherein the lighter and darker bands subtend a visual angle that is between from about 0.5 and about 8 times a subtended visual angle of a smallest dimension of the feature to be evaluated.

9. The inspection device of claim 1, wherein the lighter bands are provided in a width that is between from about 0.2 to about 1.5 times the width of the darker bands.

10. The inspection device of claim 1, wherein the material to be evaluated comprises at least one feature to be evaluated, and wherein the material to be evaluated is in motion until at least one feature to be evaluated is detected by the viewing system.

11. The inspection device of claim 1, wherein the viewing system is capable of detecting and recording aspects of features of the material to be evaluated.

12. The inspection device of claim 1, wherein the viewing system is a human being who visually evaluates the material to be evaluated.

13. The inspection device of claim 1, wherein the distance of the material to be evaluated from the viewing system is from about 20 percent to about 90 percent of the distance from the viewing system to the illumination source.

14. The inspection device of claim 1, wherein an angle between a long axis of the bands of illumination and a long axis of a feature to be evaluated is from about 15 degrees to about 70 degrees.

15. The inspection device of claim 1, wherein the material to be evaluated comprises a layered material having at least two layers.

16. The inspection device of claim 1, wherein the material to be evaluated comprises a layered material having at least three layers, wherein at least one layer is sandwiched between one or more other layers.

17. The inspection device of claim 1, wherein the illumination source emits a colored light.

18. The inspection device of claim 1, wherein the illumination source emits a substantially monochromatic illumination.

19. An inspection process comprising:
placing a material to be evaluated between an illumination source emitting illumination that is divided into lighter and darker bands and a viewing system placed a first distance from the illumination source;
wherein the material to be evaluated is placed at a second intermediate distance between the illumination source and the viewing system, the material to be evaluated also placed on an imaginary line connecting the viewing system and at least some portion of the source of illumination;
illuminating the material to be evaluated with the illumination source; and
evaluating the material to be evaluated with the viewing system.

20. The inspection process of claim 20, wherein illuminating the material to be evaluating comprises creating a field of illumination by placing a transparency on a light box, wherein the transparency contains a regular pattern of lighter and darker bars.
